(19) United States
(12) Patent Application Publication
(10) Pub. No.: US 2022/0289640 A1
(43) Pub. Date: Sep. 15, 2022

(54) CONTROLLED ENVIRONMENT AGRICULTURE

(71) Applicant: 3 RIDGE TECHNOLOGIES INC., Lynchburg, VA (US)

(72) Inventors: William LAYTON, Lynchburg, VA (US); Brittany Gallahan, Lynchburg, VA (US); Bimal Sareen, Lynchburg, VA (US)

(21) Appl. No.: 17/410,198

(22) Filed: Aug. 24, 2021

Related U.S. Application Data
(60) Provisional application No. 63/158,883, filed on Mar. 9, 2021.

(51) Int. Cl. C05F 11/08; C05F 11/02; C05F 17/05; C05G 3/80; C05G 5/40; A01G 24/20; A01G 24/40; A01G 13/02; A01G 7/04

(52) U.S. Cl. CPC C05F 11/08; C05F 11/02; C05F 17/05; C05G 3/80; C05G 5/40; A01G 24/20; A01G 24/40; A01G 13/0268; A01G 7/045

(57) ABSTRACT

In an embodiment, the present invention relates to a composition and a system. The invention relates to controlled environment agriculture comprising composition comprising a controlled growth medium comprising a customizable (generally self-regulating) microbiome, an inoculant, a natural fiber, and a soil conditioner and a system for vertical farming and sensors. The invention further relates to system for pest management.

### CROSS-REFERENCE TO RELATED APPLICATIONS

This application claims benefit of U.S. provisional Patent Application No. 63/158,883, filed on Mar. 9, 2021, titled as “Controlled Environment Agriculture”, which is hereby incorporated by reference in its entirety.

### FIELD OF THE INVENTION

This invention relates to a controlled environment agriculture comprising a composition free of harmful chemical fertilizers for agriculture not limited to a vertical farming. The invention further relates to a method to carry a controlled environment agriculture free of harmful chemical fertilizers.

### BACKGROUND

Traditional farming often employs chemical substitutes in form of chemical fertilizer and pesticides for fast and quick growth of plants. These chemical substitutes can be a hazardous on the health of human laborers working on fields.

Chemical fertilizers on long use also pose a lot of disadvantages to the overall quality of soil properties also. They affect micro-organisms living in the soil by effecting the acidity, basicity, or pH of the growing medium. Overabundance of nitrogen in relation to phosphate make the plants susceptible to mosaic infections. Chemical fertilizers also destroy beneficial microbial nutrients present in soil as a natural fertilizer.

Similarly, there are a lot of disadvantages of chemical pesticides also. They include not limited to domestic animal contaminations and deaths, loss of natural antagonists to pests, pesticide resistance, Honeybee and pollination decline, losses to adjacent crops, fishery and bird losses, and contamination of groundwater. That is why traditional farming is getting replaced with the controlled environmental farming using hydroponics or other similar systems based on chemical nutrients, chemical fertilizers, chemical pesticides.

Controlled-environment agriculture (CEA) is a technology-based approach toward food production. The aim of CEA is to provide protection and maintain optimal growing conditions throughout the development of the crop. Production takes place within an enclosed growing structure such as a greenhouse or building. Plants are often grown using hydroponic methods in order to supply the proper amounts of water and nutrients to the root zone. CEA attempts to optimize the use of resources such as water, energy, space, capital and labor. CEA technologies include hydroponics, aeroponics, aquaculture, and aquaponics.

US2018/0343810A discloses “The present disclosure is directed to improved vertical farming using autonomous systems and methods for growing edible plants, using improved stacking and shelving units configured to allow for gravity—based irrigation, gravity—based loading and unloading, along with a system for autonomous rotation , incorporating novel plant—growing pallets, while being photographed and recorded by camera systems incorporating three dimensional/multispectral cameras, with the images and data recorded automatically sent to a database for processing and for gauging plant health, pest and/or disease issues, and plant life cycle. The present disclosure is also directed to novel harvesting methods, novel modular lighting, novel light intensity management systems, real time

vision analysis that allows for the dynamic adjustment and optimization of the plant growing environment, and a novel rack structure system that allows for simplified building and enlarging of vertical farming rack systems.”

WO2021/019578 discloses “system for in-soil vertical fanning, and said system comprising: a polyhouse comprising an array of vertically stacked trays, in that, each tray being spaced apart from a vertically adjacent tray, each tray comprising soil media which fills up to two-thirds the height of said tray, each tray comprising prepared soil media, a seeding template, associated drip irrigation outlets and associated netting.”

However, the controlled environment agriculture or greenhouse uses a lot of agrochemicals, a tight control of pH and a lot of use of pesticides etc. which makes the controlled environment agriculture a complex technique.

US20170208757A1 discloses “Irrespective of the particular technique, the success of greenhouse horticulture primarily lies in the control and management of growth conditions, in particular, the nutrient solution. Consideration of the nutritional composition, pH, EC (electrical conductivity), temperature, oxygen content, etc. of the nutrient solution, over the various stages of a crop's lifecycle for the particular type of plant, must be made. Controlling these parameters has been facilitated by various computer technologies and automation tools.”

The extensive control of parameters in controlled environment agriculture do not let it use the advantage of traditional farming, and the products are grown without natural flavor and natural plant defenses. Therefore, none of the known agriculture system are disclosed which employs natural sources to harvest the maximum yield from plant including management of pest.

Due to this, there is a long-felt need, to replace chemical fertilizers, agrochemicals, continuous irrigation, use of pesticides, fungicides etc. To solve the long-standing problem, the present invention leads to understand the needs of the crops, and to help them grow in an optimal manner.

The present application is about a comprehensive growing system without use of artificial chemicals, pesticides and fertilizers, and which is naturally more resilient to temperature swings, higher in productivity, and packed with natural flavor and efficient as compared to traditional or hydroponics or aquaponics farming.

### SUMMARY

The present application is about a comprehensive growing system without use of any artificial chemicals, pesticides and fertilizers, and which is naturally more resilient to temperature swings, higher in productivity, and packed with natural flavor and more efficient as compared to traditional or hydroponics or aquaponics farming.

In an embodiment the invention relates to growth procedures designed to be simple and are intended to leave behind the complexity associated with either general agriculture, which uses chemical fertilizers and pesticides, especially as their application is required many times prior to, and during the crop growth cycle, and often unpredictably with pesticides as and when these chemically grown crops with increased susceptibility to pests and fungal afflictions.

In an embodiment, growth procedures are intended to simplify the enormous complexity of growing with hydroponics or aquaponics which use chemicals-based nutrients in a necessarily tightly balanced pH environment and are more susceptible to crop losses with any slight imbalance in pH levels.

In an embodiment, the present invention does not expect a technologist or a chemist to maintain the fine pH balance hydroponics requires. Further, in contrast to hydroponics, the present invention does not require a continually thoroughly clean the tubs and the tubes of roots, and flush and replace the artificial growth liquid of these complex hydroponics systems.

In an embodiment, the present invention is a close-to-nature system is designed to bring nature indoors for what farming was intended to be.

An embodiment relates to compositions, methods and systems for agriculture management, controlled environment agriculture, pest management, and procedures related to plant growth.

An embodiment relates to a composition comprising: a controlled growth medium comprising: a customizable microbiome, an inoculant, a natural fiber, and a soil conditioner and environmental control for customizable micro-environments.

In an embodiment, the natural fiber comprises Aback Bagasse, Bamboo, Coir, Cotton, Fique, Flax, Linen, Hemp, Jute, Kapok, Kenaf, Lotus, silk, Piña, Pine, Raffia, Ramie, Rattan, and Sisal.

In an embodiment, the natural fiber is an untreated jute. The untreated jute signify no chemical treated jute.

In an embodiment, the natural fiber is a disposed untreated jute.

In an embodiment, soil conditioner is a prehistoric humate.

In an embodiment, the composition is for non-liquid medium.

In an embodiment, the composition is configured for controlled environment agriculture without hydroponics.

In an embodiment, the controlled growth medium of claim 1, comprising compost with and without and sand.

In an embodiment, the controlled growth medium contains no chemical pesticide or no chemical fertilizer or no artificial ingredient.

In an embodiment, the controlled growth medium is carbon rich.

In an embodiment, carbon is about 30%, about 35%, about 40%, about 45%, about 50%, about 55%, about 60%, about 70% of the controlled growth medium.

In an embodiment, the controlled growth medium having minerality and further the minerality of the controlled growth medium is about 0% about 15%.

In an embodiment, the composition is layered into a form of a layer in the container, wherein the layer is substantially configured to be required in a configurable thin layer of ¼″, ½″, ¾″, 1″, 2″, 4″, 6″ and other dimensions of any container for the plantation of a crop.

In an embodiment, the crop can be any plant or plant product which needs to be grown and harvested extensively for profit or subsistence.

In an embodiment, the crop can be amaranth, arugula, bachelor button, cilantro, strawberry, tomato.

In an embodiment, growth procedure for each crop is customized preferably.

In an embodiment, the composition further comprising the composition and a container that allows for multiple harvest of crops.

An embodiment relates to an integrated pest management (IPM) system comprising the composition, wherein the IPM system is configured for controlled environment agriculture.

An embodiment relates to the integrated pest management system, further comprising: a biological mean, a structure for biological mean retention and a food source for biological mean.

An embodiment relates to the biological mean comprising a biological control bug.

In an embodiment, the biological control bug comprises a Ladybug, green lacewings, predatory mites, and worms.

In an embodiment, the structures comprising a banker and/or an umbrella (umbra) shaped plant.

In an embodiment, umbrella shaped plants comprising but not limited to cilantro flowers, yarrow, carrot flowers, dill/fennel flowers, elderberry flowers, queen anne's Lace, sea lavender.

In an embodiment, the food sources comprising but not limited to natural enemies, artificial sugars, pollen, aphids, mites, insect eggs.

In an embodiment, the biological mean comprising but not limited a nematode.

In an embodiment, nematodes belong to the families of Steinemematidae and Heterorhabditidae.

In an embodiment, nematodes comprising an entomopahogenic nematodes.

An embodiment relates to a method comprising inoculation and re-inoculation of the biological means.

In an embodiment, inoculation and re-inoculation is according to inoculation number.

In an embodiment, the composition further comprising a sensor-based control and communications network that is configured to monitor various environmental and growing parameters.

In an embodiment, the controlled growth medium comprising a crop scraps, a wood debris, a hay, fallen leaves, food scraps, a disposed jute.

In an embodiment, the controlled growth medium is cut with sand for aeration.

In an embodiment, the controlled growth media and sand are in the ratio of 60-90:10-40.

In an embodiment, the controlled growth medium is cut with silt.

In an embodiment, the inoculant comprises at least one of an organic fertilizer, a seaweed, a humic acid, a worm casting.

In an embodiment, the customizable microbiomes are selected on the basis of the specific biome requirements of each plant for optimal growth.

In an embodiment, the customizable microbiome, comprising at least one of a bacterial system, a fungi system, a nematode, a protozoa, a flagellate.

In an embodiment, flagellates are preferable.

In an embodiment, nematodes are added after the fungal system is established.

In an embodiment, a natural, biological or supplemented physical tiller by tilling process reverts one type of microbiome to another.

An embodiment relates to a system for vertical farming comprising the composition comprises: a controlled growth medium in a support comprising wire, fabric, growth media and jute, wherein support allows pruning of plants in air; wherein the system is configured for controlled environment agriculture without hydroponics.

In an embodiment, the system consisting of a layer made up of metallic or plastic wire on the outermost side followed by landscape fabric and by growth media and then by upper surface layer.

In an embodiment, upper surface layer can be covered with a fabric layer.

In an embodiment, the upper surface layer can be covered with jute.

An embodiment relates to the system comprising a device, wherein the device comprising a robotic device, a manual device, a partly robotic device, and a partly manual device.

In an embodiment, the system further comprising a UV light. The UV light could be used for pest management.

In an embodiment, the system further comprising a non-UV customizable multi-spectral light. This light could be used for regular growing of plants.

In an embodiment, the system further comprising a sensor.

In an embodiment, the system further comprising a controller.

In an embodiment, the system further comprising a communication device.

In an embodiment, the robotic device comprises a robotic tiller, a robotic seeder, a robotic harvester and a robotic cutter.

In an embodiment, the robotic device is guided on a track attached to the support.

In an embodiment, the system is configured to enable germination of a seed directly on a surface of the growth medium such that a seedling does not require transplantation.

In an embodiment, the UV and non -UV light is customizable and/or programmable.

In an embodiment, the support comprises a plurality of racks arranged in a vertical spatial arrangement configured to allow vertical farming.

In an embodiment, the system further comprising a rack holder and wherein the plurality of racks are hanging from the rack holder.

In an embodiment, the plurality of racks are thin racks and/or deep racks and/or hanging system and/or shipping container.

In an embodiment, the support does not include a tray.

In an embodiment, the manual device comprises a manual tiller, a manual seeder, a manual harvester and a manual cutter.

In an embodiment, the manual seeder comprises a seed insert and a seed holder.

In an embodiment, the sensor is configured to measure soil moisture, soil temperature, soil pH, air, relative humidity, air temperature, air flow, light, radiation, motion, water flow, and/or water temperature.

In an embodiment, the controller comprises a robotic controller configured to control the robotic device.

In an embodiment, the robotic controller is controlled via a cloud-based system, a computer, and/or a cell phone.

In an embodiment, the system further comprising a device for data capture and intelligent analysis.

In an embodiment, the support comprises a frame, a tray, a rack, a mesh, and/or a fabric.

In an embodiment, the mesh comprises metal, plastic, wood, and/or a natural product.

In an embodiment, the plurality of racks having columns configured to adjusting vertically as well as horizontally.

In an embodiment, the present invention disclose controlled environment agriculture composition combines with a focus on vertical farming with traditional close-to-nature, not industrial, simplified farming practices; and sensor and information and communication technologies; and eventually integrating with robotics.

In an embodiment, the present application is about a comprehensive growing system without use of any artificial chemicals, pesticides and fertilizers, and which is naturally more resilient to temperature swings, higher in productivity, and packed with natural flavor as compared to traditional or hydroponics or aquaponics farming.

### BRIEF DESCRIPTION OF THE FIGURES

The patent or application file contains at least one drawing executed in color. Copies of this patent or patent application publication with color drawing(s) will be provided by the Office upon request and payment of the necessary fee.

The figures are furnished with the application to understand the invention sought to be patented. It shall not be construed as only way to perform the invention has sought to be patented.

FIG. 1 shows a view of racks according to one embodiment of this invention.

FIG. 2 shows an arrangement of hanging system according to this invention.

FIG. 3 shows some different parameters studied for growth of plants.

FIG. 4 shows some different parameters studied for growth of Amaranth.

FIG. 5 shows a standard harvesting appearance of Amaranth in top view on controlled growth medium according to one embodiment of this invention.

FIG. 6(A) shows some different parameters studied for growth of Microgreen Arugula.

FIG. 6(B) shows a standard harvesting appearance of Microgreen Arugula in top view on controlled growth medium according to one embodiment of this invention.

FIG. 7 shows some different parameters studied for growth of Baby Green Arugula.

FIG. 8 shows some different parameters studied for growth of mature Arugula.

FIG. 9(A) shows some different parameters studied for growth of Bachelor Button.

FIG. 9(B) shows a standard harvesting appearance of Bachelor Button on controlled growth medium according to one embodiment of this invention.

FIG. 10 shows a comparison of present invention with hydroponics.

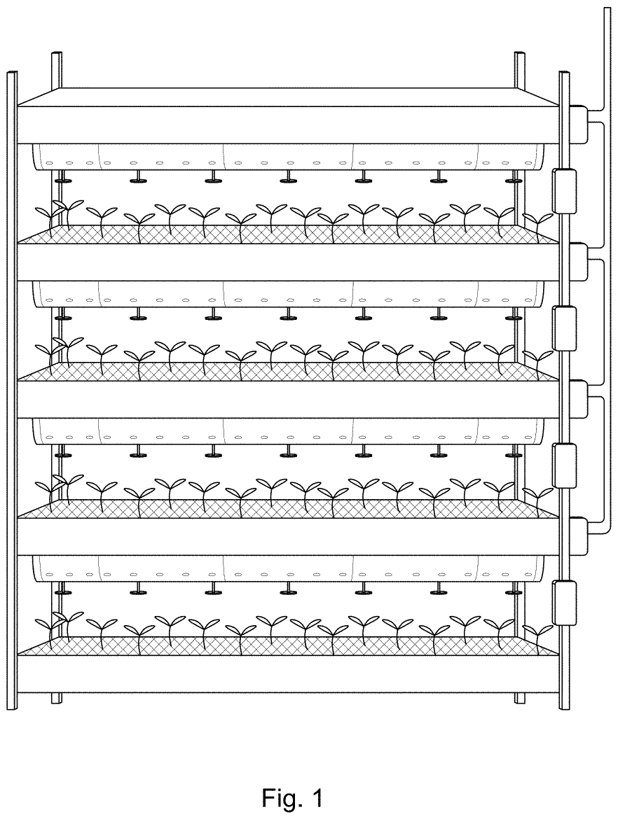

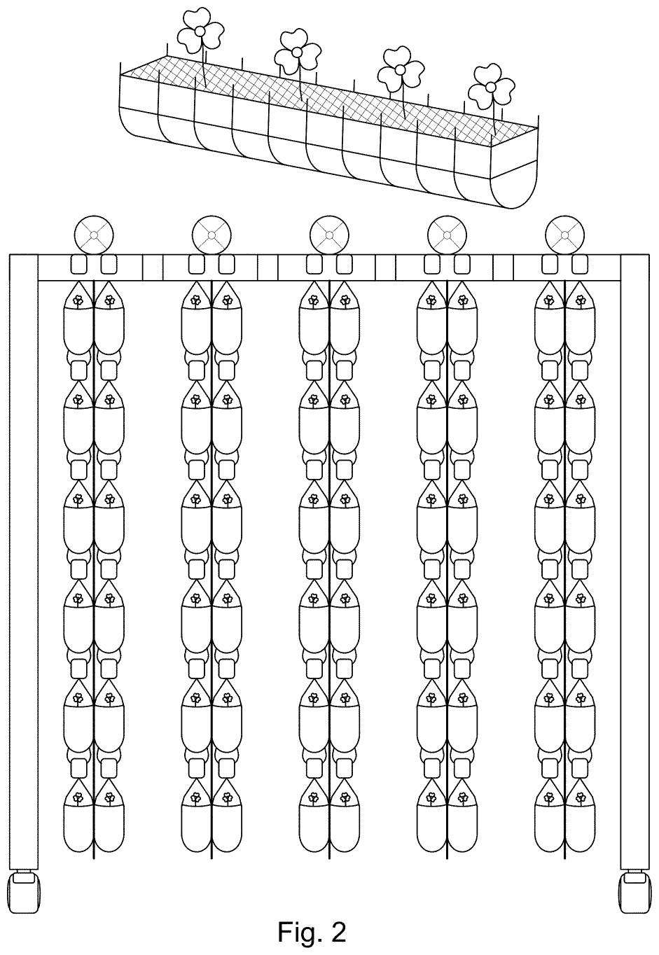

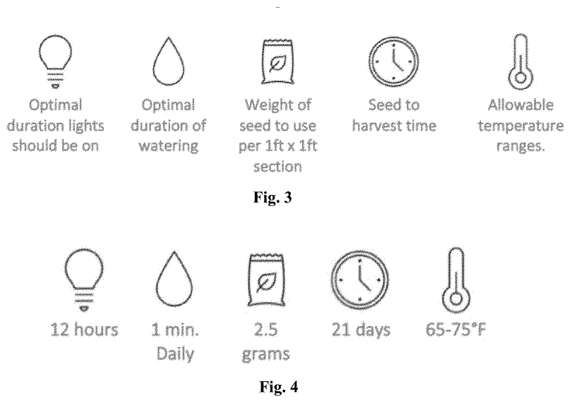

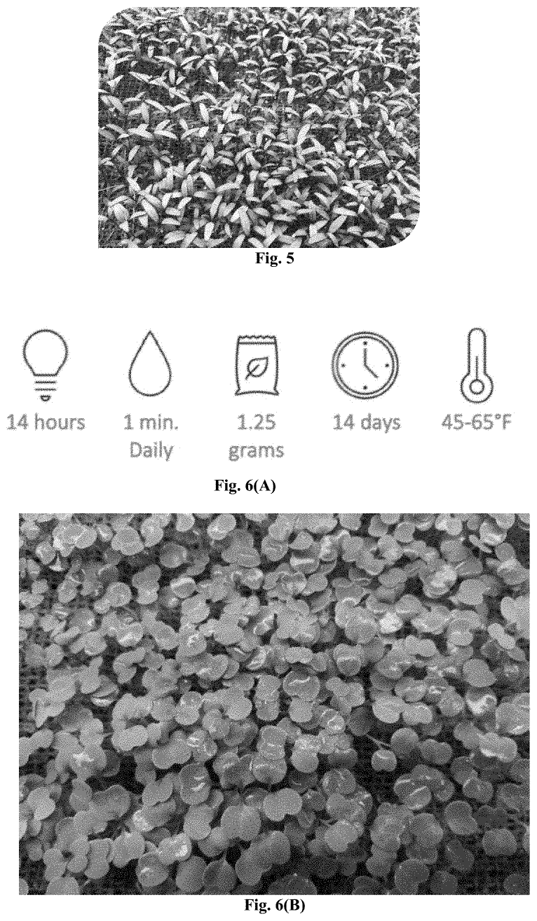

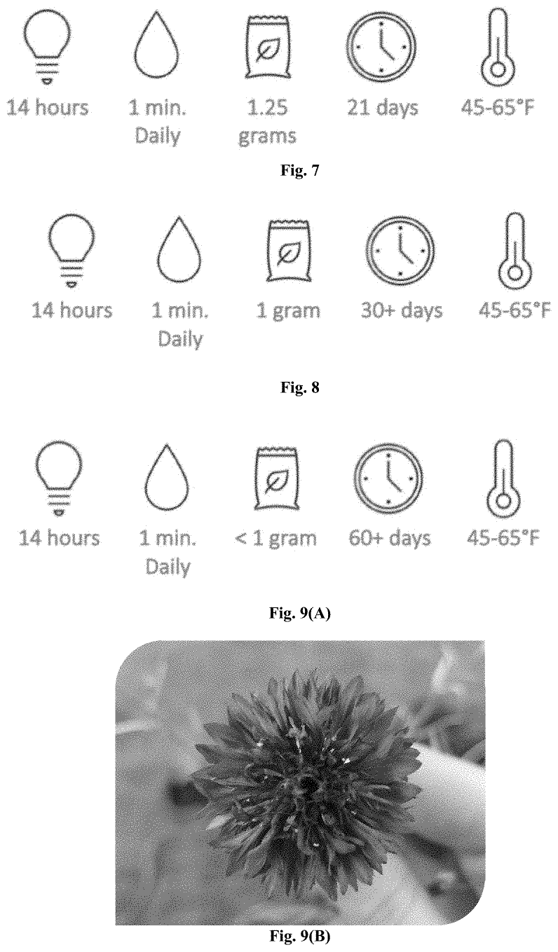

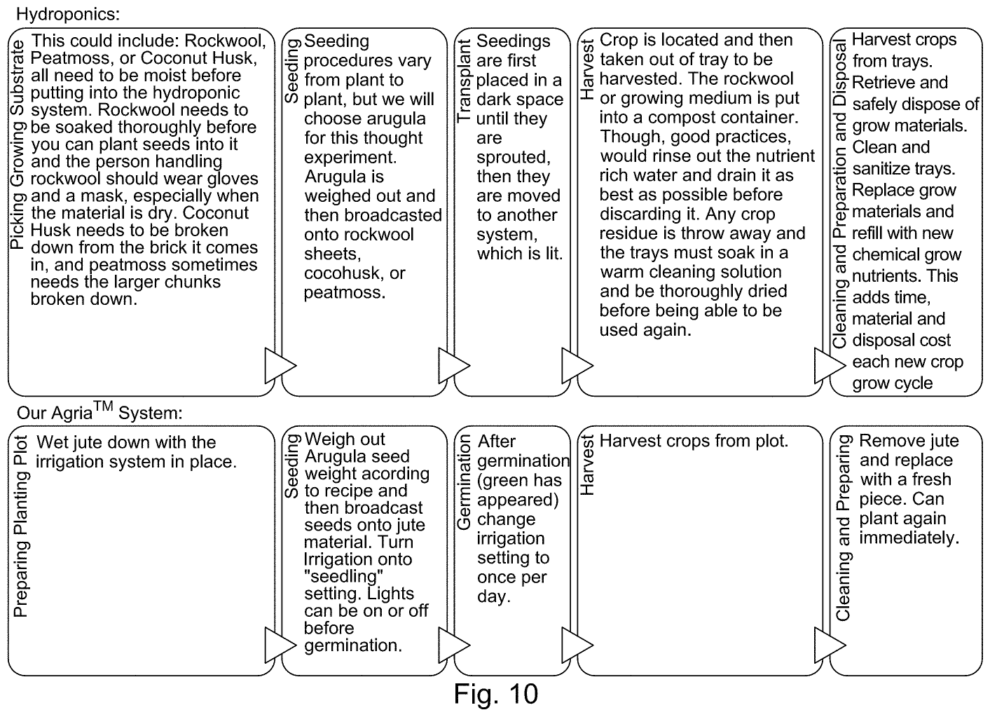

### DETAILED DESCRIPTION

### Definitions and General Techniques

For simplicity and clarity of illustration, the drawing illustrates the general manner of construction. Descriptions and details of well-known features and techniques may be omitted to avoid unnecessarily obscuring the present disclosure. Additionally, elements in the drawing are not necessarily drawn to scale. For example, the dimensions of some of the elements in the figures may be exaggerated, relative to other elements, to help improve the understanding of embodiments of the present disclosure. The same reference numeral in different figures denotes the same element.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

No element, act, or instruction used herein should be construed as critical or essential unless explicitly described as such. Also, as used herein, the articles “a” and “an” are intended to include items and may be used interchangeably with “one or more.” Furthermore, as used herein, the term “set” is intended to include items (e.g., related items, unrelated items, a combination of related items, and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent, or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real time” encompasses operations that occur in “near” real time or somewhat delayed from a triggering event. In a number of embodiments, “real time” can mean real time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As defined herein, “about” can, in some embodiments, mean within plus or minus five units of the stated value. In other embodiments, “about” can mean within plus or minus three units of the stated value. In further embodiments, “about” can mean within plus or minus two units of the stated value. In yet other embodiments, “about” can mean within plus or minus one unit of the stated value.

Unless otherwise defined herein, scientific and technical terms used in connection with the present invention shall have the meanings that are commonly understood by those of ordinary skill in the art. Further, unless otherwise required by context, singular terms shall include pluralities and plural terms shall include the singular. Generally, nomenclatures used in connection with, and techniques of, health monitoring described herein are those well-known and commonly used in the art.

The methods and techniques of the present invention are generally performed according to conventional methods well known in the art and as described in various general and more specific references that are cited and discussed throughout the present specification unless otherwise indicated. The nomenclatures used in connection with, and the procedures and techniques of embodiments herein, and other related fields described herein are those well-known and commonly used in the art.

Reference throughout the specification to “various embodiments,” “some embodiments,” “one embodiment,” or “an embodiment”, or the like, means that a particular feature, structure, or characteristic described in connection with the embodiment is included in at least one embodiment. Thus, appearances of the phrases “in various embodiments,” “in some embodiments,” “in one embodiment”, or “in an embodiment”, or the like, in places throughout the specification are not necessarily all referring to the same embodiment.

Furthermore, the features, structures, or characteristics may be combined in any suitable manner in one or more embodiments. Thus, the features, structures, or characteristics illustrated or described in connection with one embodiment may be combined, in whole or in part, with the features structures, or characteristics of one or more other embodiments without limitation. Such modifications and variations are intended to be included within the scope of the present invention.

The following terms and phrases, unless otherwise indicated, shall be understood to have the following meanings.

Agriculture management—includes management of complete process carried during cultivation of plants including planning, supervising, planting, fertilization, and harvesting process. It may also deal with farming techniques, the domestication of animals, and the general processing of food.

Controlled environment agriculture—Controlled-environment agriculture (CEA) is a technology-based approach to carry on agriculture practices. The aim of CEA is to provide protection and maintain optimal growing conditions throughout the development of the crop. CEA optimizes the use of resources such as water, energy, space, capital and labor. The agriculture practices may take place within an enclosed growing structure such as a greenhouse or building.

Pest—A pest is any animal or plant harmful to humans or human concerns. The term is particularly used for creatures that damage crops, food, livestock, and forestry or cause a nuisance to people.

Pesticide—Pesticides are substances that are meant to control pests. The term pesticide includes all of the following: herbicide, insecticides (which may include insect growth regulators, termiticides, etc.) nematicide, molluscicide, piscicide, avicide, rodenticide, bactericide, insect repellent, animal repellent, antimicrobial, and fungicide. In general, a pesticide is a chemical pesticide (such as carbamate). Target pests can include insects, plant pathogens, weeds, molluscs, birds, mammals, fish, nematodes (roundworms), and microbes that destroy property, cause nuisance, or spread disease, or are disease vectors. Along with these benefits, pesticides also have drawbacks, such as potential toxicity to humans and other species. Prominent chemical insecticide families include organochlorines, organophosphates, and carbamates. Organochlorine hydrocarbons (e.g., DDT) could be separated into dichlorodiphenyl ethanes, cyclodiene compounds, and other related compounds. They work by different mechanisms.

Biopesticides are certain types of pesticides derived from such natural materials as animals, plants, bacteria, and certain minerals. For example, canola oil and baking soda have pesticidal applications and are considered biopesticides. They are biological agent (such as a virus, bacterium, or fungus) that deters, incapacitates, kills, or otherwise discourages pests. Biological agents also include but not limited to bugs, nematodes, insects.

Pest management—Pest control is the regulation or management of a species defined as a pest. Diseases, insects, and weeds can cause costly and irreparable harm to livestock and crops. In an embodiment, pest management employs biopesticides,

Biological mean—It refers to a use of living things to destroy or damage or control the population of other living thing.

Hydroponics—Hydroponics is a type of horticulture which involves growing plants without soil, by using mineral nutrient solutions in an aqueous solvent. Plants may grow with their roots exposed to the nutritious liquid, or, in addition, the roots may be physically supported by an inert medium such as perlite, gravel, or other substrates.

Medium—the thing by which or through which something is done or the substance in which something lives or acts.

Growth medium—A growth medium is macro or micro components such as nutrients, for example and without limitation, any vitamins, minerals, organic components for the growth of the plants or crops. It not only provides the essential nutrients to the plant or crops but also provides the physical support to them, acts as a mean of water storage and a habitat for microbiome. Sometimes it also acts as a recycling system. The physical like texture, structure, density porosity, consistency, temperature etc., chemical properties like nutritional factors, biological factors like type of microbiome have an overall effect on the growth of stem, roots and leaves of plant or crop and the yield. The growth medium may also help in providing support to plants.

Controlled Growth medium—A controlled growth medium is specifically designed growth medium according to requirements for each crop or plant to grow. A controlled growth medium has a set drainage depending on the crop being grown. The controlled growth medium never comes in contact with the ground. The controlled growth medium houses a controlled micro biome and its constitution is optimized for each one.

Minerality—Minerality refers amount and type of minerals present in medium. Some of the minerals found in growth medium are but not limited to silicate or silica compounds, Iron, Potassium, Magnesium, Calcium, Sulphur etc.

Fertilizer—Fertilizer is a chemical or natural substance added to soil or land to increase its fertility. A fertilizer is any material of natural or synthetic origin that is applied to soil or to plant tissues to supply plant nutrients. Fertilizers may be distinct from liming materials or other non-nutrient soil amendments.

Chemical Fertilizer—These are also called as synthetic fertilizer. These are man-made and employ various chemicals. For example, but not limited to, an ammonia is used to make nitric acid, with which it is then mixed to produce nitrate fertilizers such as ammonium nitrate (AN). Ammonia may also be mixed with liquid carbon dioxide to create urea. Both these products can be further mixed together with water to form UAN (urea ammonium nitrate) solution. NPK (a combination of Nitrogen, Potassium and Phosphorous) is the most common chemical fertilizer added for the plants.

Compost—Compost is a decayed organic material used as a fertilizer for growing plants. Composting is an aerobic method (meaning that it requires the presence of air) of decomposing organic solid wastes. It can therefore be used to recycle organic material. The process involves decomposition of organic material into a humus-like material, known as compost, which is a good fertilizer for plants.

Crop scrap—crop scrap is the waste generated from crops. It may be dry or wet scrap. It is generally generated during harvesting.

Wood debris—wood debris is the debris generated from woody plants.

Hay—Hay is grass, legumes, or other herbaceous plants that have been cut and dried to be stored for use as animal fodder.

Fallen leaves—It is generally considered as a waste. Leaf produced by abscission from the plants are considered as fallen leaves.

Food scraps—It is a waste generated from the food. It is also called as kitchen wastes.

Sand—Sand is a loose granular substance, typically pale yellowish brown, resulting from the erosion of siliceous and other rocks and forming a major constituent of beaches, river beds, the seabed, and deserts. It is an essential component of potting soils and the growth medium in the controlled environment. Nursery soil texture, permeability, structure, and compaction are all important variables during these early stages and sand percentage contribute to these variables. The type of sand used impacts the quality of the final product. Washed and screened silica-based nursery sands are ideal and are highly sought after by nursery operations. The porosity of the sand is between 37% to 47%.

Silt—It is a fine sand, clay, or other material carried by running water and deposited as a sediment, especially in a channel or harbour. Silt is smooth and slippery to the touch when wet and the individual particles are much smaller than those of sand. Therefore, it has less porosity than sand. It is added in the soil or the growth medium to change the physical properties.

Carbon rich—Carbon(C)-rich specifically for the soil or medium means carbon is present as a high percentage in medium or soil as compared to other minerals. C-rich crop residues supported larger free-living nematode populations. In an embodiment, amount of carbon is 40%, 45%, 50%, 55%, 60%, 70%, 75%, 80% w/w of the medium.

Nitrogen rich—Nitrogen(N) rich specifically for the soil or medium means nitrogen is present in a high percentage in medium compared to nitrogen present in a garden soil without any added fertilizer or compost. N-rich animal manure was more effective in controlling plant-feeding nematodes. In an embodiment, an amount of nitrogen is 15%, 20% 30%, 35%, 40%, 45%, 50%, 55%, 60%, 70% w/w of the medium.

Inoculant—Inoculant is any material, solution or organism that are added to increase the quality of the growth medium in which it is added. It may be any solid, liquid or semi-solid or any microbe or living organism also. Microbial inoculants also known as soil inoculants or bioinoculants. Microbial inoculants employ beneficial rhizosphere or endophytic microbes to promote plant health. In an embodiment, inoculation of lower-level animals but not limited to insects or bugs or nematodes are also considered as inoculants. Inoculation is prepared over time in a living habitat.

Re-inoculation—Reinoculation is addition of same inoculant matter again in same solution after a specific time for the replenishment of intended deficit.

Natural fiber—natural fiber is a fiber which is procured from a natural plant or animal source. Natural fiber from a plant source is also called as phloem fiber. The dimensions of these fibers vary between different plants with lengths in the range 1-50 mm, and diameters in the range 15-30 μm. Natural fibers could be grouped as short fibers and long fibers.

Short fibers—These fibers have a length in the range 1-5 mm, originating typically from wood species (e.g., spruce, pine, birch, eucalyptus), and typically used for making composites with in plane isotropic properties, that is, composites with a non-specific (random) fiber orientation. In the living green plants, when the fibers are fully developed, their intracellular organelles start to degenerate resulting in fibers having an empty central cavity, the so-called lumen. In wood fibers, the luminal area is in the range 20-70% of the fiber cross-sectional area.

Long fibers—These fibers have lengths in the range of 5-50 mm, originating typically from annual plant species (e.g., flax, hemp, jute), and typically used for making composites with anisotropic properties, that is, composites with a specific fiber orientation. In long fibers have a relatively smaller luminal area in the range of about 0 to about 5%.

Jute—Jute is the name of the plant or fiber used to make burlap, hessian or gunny cloth. Jute is one of the most affordable natural fibers, and second only to cotton in the amount produced and variety of uses. Jute fibers are composed primarily of the plant materials cellulose and lignin. Jute are natural long fibers. Jute has a net calorific value comparable to that of coal (18.6 Mj/kg). Jute contains almost 40% of carbon. The CO2 emission from jute is considered to be carbon neutral since the product is from plant source and can be considered as a biomass.

Disposed jute—Disposed jute is jute which is a part of waste or have been disposed not to be used in its general uses or which is already used elsewhere. Jute could be decomposed to some level by microbial action. Jute could also be disposed by methods such as but not limited to landfill disposal, incineration with energy recovery, mechanical biological treatment, recycling, composting and anaerobic digestion.

Seaweed—Seaweed or sea vegetables are forms of algae that grow in the sea. They range in color from red to green to brown to black. Seaweed, or macroalgae, refers to thousands of species of macroscopic, multicellular, marine algae. The term includes some types of Rhodophyta (red), Phaeophyta (brown) and Chlorophyta (green) macroalgae. “Seaweed” lacks a formal definition, but seaweed generally lives in the ocean and is visible to the naked eye. Seaweed species such as kelps are used to provide essential nutrient to the plants or crops.

Soil conditioner—A soil conditioner is a product which is added to soil to improve the soil's physical qualities and ability to provide nutrition to plants; a soil conditioner is not a fertilizer. In general usage, the term “soil conditioner” is often thought of as a subset of the category soil amendments (or soil improvement, soil condition), which more often is understood to include a wide range of fertilizers and non-organic materials. However, fertilizer and soil conditioners differ in the means that soil conditioner mostly change physical properties like pH, water holding capacity etc., whereas fertilizers change the chemical properties like availability of any nutrient in the soil. Soil conditioners can be used to improve poor soils, or to rebuild soils which have been damaged by improper soil management. They can make poor soils more usable and can be used to maintain soils in peak condition.

Prehistoric humate—Prehistoric humate comprises but not limited to humic acid and fulvic acid from humic shale ore. Humate is a mineral that is mined from the earth. It is an early stage in the development of coal from organic matter. Humate is rich in humic and fulvic acids, which are active components of soil humus (hence the name “humate”). It is generally used as soil conditioner.

Humic acid—Humic acid is a group of molecules that bind to, and help plant roots receive, water and nutrients. High humic acid levels can dramatically increase yields. Humic acid deficiency can prevent farmers and gardeners from growing crops with optimum nutrition. Humic substances are organic compounds that are important components of humus, the major organic fraction of soil, peat, and coal (and also a constituent of many upland streams, dystrophic lakes, and ocean water).

Worm casting—Worm castings are an organic fertilizer produced from earthworms. Also known as vermicast, worm castings manure is essentially earthworm waste, otherwise known as worm poo. As these creatures eat through compost, their waste creates an optimal soil enricher. Worm castings resemble football-shaped particles that improve soil aeration and drainage, as well as increase water retention in the soil.

Microbiome—Microbiome is a term that describes the genome of all the microorganisms, symbiotic and pathogenic, living in and on all vertebrates. In another embodiment, microbiome is a community of microorganisms (such as bacteria, fungi, and viruses) that inhabit a particular environment and especially the collection of microorganisms living in or on the human body or soil or growth medium. This may be differentiated into different systems named after the dominancy of one type of microbes or low level organism. Microbiome really effect the proper growth of the plant by increasing the availability of nutrients, gorging on the pests, changing the pH etc.

Customizable microbiome—customizable microbiome means microbiome customized according to crop or plant to be grown. Depending on the preferences of the crop, a microbiome is developed to optimize growth. The customizable microbiome includes at least three trophic levels. The customizable microbiome is also regulated by the food sources found in the customizable growth medium and mechanical interactions, such as tilling.

In an embodiment, trophic levels are as an integrated and essential element in developing customized biomes that are developed for each crop in grow system.

In an embodiment, trophic levels are the levels of each organism it occupies in a food web. A food chain is a succession of organisms that eat other organisms. A food web starts at trophic level 1 with primary producers such as plants, can move to herbivores at level 2, carnivores at level 3 or higher, and typically finish with apex predators at level 4 or 5.

In an embodiment, multiple trophic levels are used that is customized for each crop microbiome that is developed, in turn using ecological principals to drive energy transfer, where the trophic levels help define the transfer, which happen in soil systems that are alive. Fertilizers typically disrupt this and break the food chain.

Bacterial system—Bacterial system is the interaction system by the different genus or species of all bacteria present in the growth medium.

Fungi system—Fungi system is the interaction system by the different species of all fungal genus or species present in the growth medium.

Nematodes—The nematodes or roundworms belongs to phylum of Nematoda (also called Nemathelminthes), with plant-parasitic nematodes being known as eelworms. They are a diverse animal phylum inhabiting a broad range of environments. Taxonomically, they are classified along with insects and other moulting animals in the clade, Ecdysozoa, and unlike flatworms, have tubular digestive systems with openings at both ends. The beneficial nematodes are added in the growth medium or soil to gorge on the natural pests as an ingredient of the natural pest management system.

Entomopathogen—Entomopathogens are microorganisms that are pathogenic to arthropods such as insects, mites, and ticks. Several species of naturally occurring bacteria, fungi, nematodes, and viruses infect a variety of arthropod pests and play an important role in their management. Entomopathogens may also be used as biopesticides in pest management.

Entomopathogenic nematodes—entomopathogenic nematodes are soft bodied, non-segmented roundworms that are obligate or sometimes facultative parasites of insects. Entomopathogenic nematodes occur naturally in soil environments and locate their host in response to carbon dioxide, vibration and other chemical cues. Species in two families (Heterorhabditidae and Steinernematidae) have been effectively used as biological insecticides in pest management programs. Entomopathogenic nematodes fit nicely into integrated pest management or IPM programs because they are considered non-toxic to humans, relatively specific to their target pest(s), and can be applied with standard pesticide equipment.

Centipedes—Centipedes (centi- “hundred” and pedis- “foot”) are predatory arthropods belonging to the class Chilopoda of the subphylum Myriapoda, an arthropod group which also includes millipedes and other multi-legged creatures. Centipedes can be a part of the customizable microbiome.

Protozoa- Protozoa is an informal term for a group of single-celled eukaryotes, either free-living or parasitic, that feeds on organic matter such as other microorganisms or organic tissues and debris. Historically, protozoans were regarded as “one-celled animals”, because they often possess animal-like behaviours, such as motility and predation, and lack a cell wall, as found in plants and many algae. Although the traditional practice of grouping protozoa with animals is no longer considered valid, the term continues to be used in a loose way to describe single-celled protists (that is, eukaryotes that are not animals, plants, or fungi) that feed by heterotrophy. Some examples of protozoa are Amoeba, Paramecium, Euglena and Trypanosoma. These can be a part of the customizable microbiome.

Flagellates—A flagellate is a cell or organism with one or more whip-like appendages called flagella. The word flagellate also describes a particular construction characteristic of many prokaryotes and eukaryotes and their means of motion. It can be a part of customizable microbiome. There are protozoan species also with flagella.

Umbrella (umbral) shaped plants—These are the plants related to the Umbelliferae family. These plants are generally used in the controlled agriculture environment to support the means.

Ladybug—Coccinellidae (also known as Ladybug in North America) is a widespread family of small beetles ranging in size from 0.8 to 18 mm (0.03 to 0.71 in).

Banker plants—A Banker plant is a plant that has a population of reproducing natural enemies on it. This terminology is restrictive and does not allow for the sachets used to produce N. Cucumeris or the bucket rearing system used to produce parasitoids and predators of measlybugs.

Biological control bug—Biological control or biocontrol is a method of controlling pests such as insects, mites, weeds and plant diseases using other organisms. It relies on predation, parasitism, herbivory, or other natural mechanisms, but typically also involves an active human management role. It can be an important component of integrated pest management (IPM) programs.

Germination—Germination is the process by which an organism grows from a seed or similar structure. The term is applied to the sprouting of a seedling from a seed of an angiosperm or gymnosperm.

Seed—A seed is an embryonic plant enclosed in a protective outer covering. The formation of the seed is part of the process of reproduction in seed plants, the spermatophytes, including the gymnosperm and angiosperm plants.

Tilling—Tilling is the agricultural preparation of soil by mechanical or biological agitation of various types, such as digging, stirring, and overturning. Examples of human-powered tilling methods using hand tools include shoveling, picking, mattock work, hoeing, and raking. Tilling help in increasing the water storage properties, availability of nutrients etc. It can be used for microbiome regulation.

In an embodiment, an integrated biological tilling is an integrated part of the grow system. In yet another embodiment, biological tilling is used in a customized manner depending on the type of crop to developing customized biomes. This may be supplemental to optional mechanical tilling.

In an embodiment, biological tilling is a natural process of decompaction, and aeration done by organisms that live in the soil.

Seedling—A seedling is a young sporophyte developing out of a plant embryo from a seed. Seedling development starts with germination of the seed. A typical young seedling consists of three main parts: the radicle (embryonic root), the hypocotyl (embryonic shoot), and the cotyledons (seed leaves). The two classes of flowering plants (angiosperms) are distinguished by their numbers of seed leaves: monocotyledons (monocots) have one blade-shaped cotyledon, whereas dicotyledons (dicots) possess two round cotyledons. Sometimes, plants or crops are grown from seedling in the main field rather than seed.

Transplantation—In agriculture, transplanting or replanting is the technique of moving a plant from one location to another. Most often this takes the form of starting a plant from seed in optimal conditions, such as in a greenhouse or protected nursery bed, then replanting it in another, usually outdoor, growing location. Some crops are more effective to grow from seedlings rather than seeds. However, it causes a wastage of time, resources and labor. So, there is a need to decrease the transplantation step in the crops or plants.

Natural product—A natural product is a chemical compound or substance produced by a nature.

Air pruning—Air pruning happens naturally when roots are exposed to air in the absence of high humidity. The roots are effectively “burned” off, causing the plant to constantly produce new and healthy branching roots. If roots are not exposed to air, they continue to grow around the container in a constricted pattern.

Vertical farming—Vertical farming is the practice of growing crops in vertically stacked layers. It often incorporates controlled-environment agriculture, which aims to optimize plant growth. Vertical farming could also employ soilless farming techniques such as but not limited to hydroponics, aquaponics, and aeroponics etc.

Hanging system—It is a system in which plants do not touch the ground but have been grown in hangers. In an embodiment, the hanging system is made of plastic, metal, mosses or any other natural or synthetic material or mixture of different materials. It can be single layered or multi-layered.

Landscape fabric—Landscape fabric is a textile material used to control weeds by inhibiting their exposure to sunlight. The fabric is normally placed around desirable plants, covering areas where other growth is unwanted. The fabric itself can be made from synthetic or organic materials, sometimes from recycled sources.

Mesh—A mesh is a barrier made of connected strands of metal, fiber, or other flexible or ductile materials. Mesh made up of fiber is also called as a fabric.

Shipping container—A shipping container is a container with strength suitable to withstand shipment, storage, and handling. Shipping containers range from large reusable steel boxes used for intermodal shipments to the ubiquitous corrugated boxes. In the context of international shipping trade, “container” or “shipping container” is virtually synonymous with “intermodal freight container” a container designed to be moved from one mode of transport to another without unloading and reloading. Sometimes these shipping containers are used for a variety of other purposes. One of them is agriculture.

Tray—A tray is a shallow platform designed for the carrying of items. It can be fashioned from numerous materials, including but not limited to brass, sheet iron, paperboard, wood, melamine, and molded pulp. Trays are flat, but with raised edges to stop things from sliding off them. They are made in a range of shapes but are commonly found in oval or rectangular forms, sometimes with cutout or attached handles with which to carry them.

Thin racks—Racks in which height of the rack is less than 5 cm.

Deep racks—Racks in which height of the rack is more than 5 cm.

Lighting systems—In agriculture, the use of artificial lighting seeks to provide a source of light that is like sun light. There are three basic types of grow lights available for indoor urban farming: fluorescent grow lights, HPS or HID grow lights, and LED grow lights. A lighting system is the whole system that control the type, intensity, or rate of the lighting in agriculture.

Heating/cooling systems—Heating and cooling systems have three basic elements—a source of warm or cool air, a method of sending the heated or cooled air and a way to control the temperature in the controlled environment agriculture.

UV light—Ultraviolet (UV) is a form of electromagnetic radiation with wavelength from 10 nm (with a corresponding frequency around 30 PHz) to 400 nm (750 THz), shorter than that of visible light, but longer than X-rays. UV radiation is present in sunlight, and constitutes about 10% of the total electromagnetic radiation output from the Sun. It is also produced by electric arcs and specialized lights, such as mercury-vapor lamps, tanning lamps, and black lights. The ultraviolet radiation comprises UV-A, UV-B and UV-C.

Among all UV radiations, only the amounts of UV-A and UV-B radiations reaching the earth surface will increase in the future. UV-C radiations, because of their high absorption level by the ozone layer, do not penetrate to the earth in any appreciable amount. UV-B radiations encompass indeed such important topics as disinfection, the stimulation of the secondary metabolism, including the production of health-promoting phytochemicals, the stimulation of the so-called plant natural defenses, etc. UV-C (Ultraviolet C) light is also known for disinfecting, sterilizing water or surfaces or for treating post-harvest plant materials such as harvested fruits and vegetables, which have been removed from the living/growing/photosynthesizing plants.

Sensor—A sensor is a device that measures physical input from its environment and converts it into data that can be interpreted by either a human or a machine. Most sensors are electronic (the data is converted into electronic data), but some are simpler, such as a glass thermometer, which presents visual data. Sensor as an input device which provides an output (signal) with respect to a specific physical quantity (input). The term “input device” in the definition of a Sensor means that it is part of a bigger system which provides input to a main control system (like a Processor or a Microcontroller). Another unique definition of a Sensor is as follows: It is a device that converts signals from one energy domain to electrical domain. The definition of the Sensor can be better understood if we take an example into consideration.

Yield rates—In agriculture, the yield is a measurement of the amount of a crop grown, or product such as wool, meat or milk produced, per unit area of land. The units by which the yield of a crop is usually measured today are kilograms per hectare or bushels per acre. Yields are related to agricultural productivity but are not synonymous. Agricultural productivity is measured in money produced per unit of land, but yields are measured in the weight of the crop produced per unit of land.

Harvest dates—The “harvest dates” refer to the periods during which harvest of the crop actually occurs. They do not extend through the subsequent period in which some commodities are stored in the field after harvest.

Wet days—Wet day (or wet days) is a day when there is sufficient moisture availability for the plant.

Food sources—Food is any substance consumed to provide nutritional support for an organism. The sources of the food can be any source whether natural plant or animal or something synthetic or lab made. In an embodiment, the food sources for lady bugs are the pests of the crops on which these feasts.

The invention is illustrated through various embodiments below.

In an embodiment, invention is intended to simplify the enormous complexity of growing with hydroponics or aquaponics which use chemicals-based nutrients in a necessarily tightly balanced pH environment and are more susceptible to crop losses with any slight imbalance in pH levels.

In an embodiment, the present invention does not require to clean the tubs and the tubes of roots continually thoroughly, and flush and replace the artificial growth liquid as done in complex hydroponics systems.

In an embodiment, invention is close-to-nature system designed to bring nature indoors for what farming was intended to be.

In an embodiment, the present application is about a comprehensive growing system without use of any artificial chemicals, pesticides and fertilizers, and which is naturally more resilient to temperature swings, higher in productivity, and packed with natural flavor as compared to traditional or hydroponics or aquaponics farming.

In an embodiment, core of the present application is a nature-based, controlled growth medium, and which allows for growth of crops in a thin controlled growth medium e.g. growing microgreens like lettuce, spinach etc. in ¾″ of controlled growth medium.

In an embodiment, the core of the present application is combined with innovative growing structures that allows for multiple harvest of crops in a space-saving way, with the core complexity in the controlled growth medium, on which relatively simple agricultural growing and maintenance procedures have been developed.

In an embodiment, comprehensive growing system is supplemented with a natural ecology-based pest management system that does not use any artificial ingredients. The compressive growing system is part of controlled environment agriculture.

In an embodiment, comprehensive growing system is further supplemented with a sensor-based control and communications network that monitors various environmental and growing parameters, and using proprietary algorithms and settings, automatically controls various environmental variables e.g., watering and lights. The multi-faceted sensor information is stored via a company cloud service and is subsequently harvested using the latest artificial intelligence techniques to further improve i.e., provide optimizations and customizations on a per-crop basis. This information also enables sophisticated remote maintenance (diagnostics and control) activities.

In an embodiment, grow-system is the customizable/programmable spectrum of the LED lights that are customized for each crop to help create a more specific micro-biome/micro-environment-controlled growth environment to provide optimum growth and pest management conditions for each crop as tuned to our unique grow-system.

In an embodiment, the comprehensive growing system is working to replace hydroponics.

In an embodiment, the comprehensive growing system will be disruptive to the fledgling hydroponics industry and its supporting chemical supported industry of artificial nutrients and artificial fertilizers.

In an embodiment, the comprehensive growing system is a complete (eventually self) regulating and automated CEA system. This includes a specialized controlled growth medium, an organic and sustainable growth layer that acts as a bio-degradable growth surface, a sensor based automated irrigation system, and sensor based environmental controls. Included is a customized lighting system with customized spectra for different crop types.

In an embodiment, an additional unique feature is the absence of a transplantation step in many crops, as the microbiome growing environment enables the germination of seeds directly on the surface itself This naturally saves time and transplant shock that many crops must deal with.

Further an embodiment of the present application relates to the microenvironments created based on each plant; and in conjunction with the microbiome for each plant provides for a self-controlled nutrient release for each plant crop.

This further helps minimize the water requirements, and minimal water usage is needed for growing healthy, nutritious, truly organic crops.

In an embodiment, invention deals with controlled growth medium. The controlled growth medium is comprised of Growth Medium Base.

In an embodiment, growth medium base is a natural compost-based carbon-rich base medium. In an embodiment, base has no artificial ingredients, or any use of animal remains.

In an embodiment, the controlled growth medium is absent of any animal waste.

In an embodiment, the controlled growth medium starts as a predominately bacterial system and then succeeds to a fugally dominated system. In an embodiment, this succession gets reverted with tilling in the racks.

In an embodiment, customize controlled growth medium batches with customized formulas for different crops is used.

In an embodiment, the controlled growth medium is cut with sand. In an embodiment, the controlled growth medium is cut with kelp. In an embodiment, the controlled growth medium contains a fungus eating nematode to further balance the system.

In an embodiment, Controlled growth medium is in the following input ratio (by weight): about 10 to about 30% crop scrap, about 15 to about 40% of Wood debris, about 5 to about 30% yellow hay or straw, about 1 to about 20% of fallen leaves, about 0 to about 10% food scraps (or vegetable waste at farm) and about 5 to about 25% of Disposed Jute.

In an embodiment, controlled growth medium base could employ a natural fiber.

In an embodiment, the natural fiber herein is long fibers that differs from wood or wood debris or wood fibers or short fibers.

The cellulose content of unprocessed fibers is in the range of 40-50% w/w for short fibers, and in the range of 60-70% w/w for long fibers.

Accordingly, the content of hemicellulose and lignin is higher in wood fibers also called as short fibers. lignin content of about 30% w/w in wood fibers, in comparison to only about 5% w/w in plant fibers. Plant fibers is also called as long fibers.

The chemical composition of short and long fibers is clearly different from each other. In addition, wood fibers show lower cellulose crystallinity than plant fibers, with typical values in the ranges of 55-70 and 90-95% w/w, respectively.

In an embodiment, crop scrap is green scrap.

In an embodiment, wood debris is wood chips.

In an embodiment, controlled growth medium is cut with sand for aeration.

In an embodiment, the sand is in ratio of 20-40% and controlled growth medium is in 60-80%. Yet in another embodiment, 25% sand, 75% controlled growth medium.

In an embodiment, fungal system is established in the controlled growth medium containing sand.

In an embodiment, fungal system is established in the controlled growth medium without sand.

In an embodiment, nematodes have been introduced. In another embodiment, introduction of nematodes is done after a few wet days.

In an embodiment, after first crop, a microbial system is established for the nematodes to have a food source. Yet another embodiment relates to a fungal system which is established for the nematodes to have a food source.

In an embodiment, the controlled growth medium is USDA Certified organic.

In an embodiment, controlled growth medium comprises an inoculant recipe comprising inoculants.

In an embodiment, the inoculation recipe is customizable for different crops.

In an embodiment, Inoculation Recipe comprises Fish Fertilizer, Seaweed Fertilizer, Soil Conditioner, Soluble Seaweed Powder, humic Acid, Alfalfa Meal, Worm Castings, Growth Medium Base.

In an embodiment, soil conditioner is from the earth's richest humate composted from prehistoric plant matter over 75 million years. In an embodiment, the soil conditioner comprises more than 70 trace minerals which aid in nutrient uptake for flowers and vegetable plants providing for optimum health and growth.

Yet, in another embodiment, the soil conditioner comprises about 1.50% sulfur and 2.25% Iron.

Yet, in another embodiment, soil conditioner employs 45% w/w of humic acid and 14% w/w of fulvic acid.

In an embodiment, controlled growth medium comprises of microbiomes.

In an embodiment, microbiome is defined as a community of microorganisms (such as bacteria, fungi, and viruses) that inhabit a particular environment and especially the collection of microorganisms living in or on the human body.

In another embodiment, microbiome is a community of microorganisms (such as bacteria, fungi, protozoa, nematodes, and amoeba) inhabiting a particular environment and especially soil systems.

Worms i.e. earthworms, nematodes etc. help facilitate a healthy soil microbiome by aerating the controlled growth medium and processing the detrital material. worm castings offer a good start to creating an inoculation for the controlled growth medium created on site.

In an embodiment, customized microbiomes for each crop by leveraging the digestion process of different organisms to see how the casting differs morphologically have been included in the growth media. The list includes different worms, and now centipedes.

In an embodiment, customizable microenvironments are provided and enabled for each crop's microbiome.

Some crops can be harvested at several stages, depending on desired product. For these, there will be multiple procedures. For example, Arugula can be harvested as a microgreen, a baby green, and a mature plant.

In an embodiment, we have made a procedure that cover a multitude of harvest types.

Microgreen is defined as the stage of growth that has only the cotyledon leaves and the emergence of a single true leaf. Cotyledon is defined as the first leaves that emerge from the seed. Baby Green is defined as the stage of growth that includes several true leaves at a small size. The cotyledon leaves are still present. Mature green is defined as a stage in which the cotyledon leaves have died back and the true leaves and large. Some leafy greens can have several harvests once they have reached their mature state. Node is defined as a branching point on the plant.

An embodiment provides a growing procedure for plants. Each crop growing has a set up of optimal duration of light, optimal duration of watering, weight of seed to use per 1 ft * 1 ft section, seed to harvest time and allowable temperature ranges.

An embodiment, provide a growth procedure for Amaranth. Amaranth is a vibrant green with a sweet, earthy flavor. The microgreen is popular for adding a bright color while not overpowering the inherent flavor of the dish.

In an embodiment, the growth procedure for Amaranth is as follows: weigh out seeds, wet jute thoroughly, scatter seeds evenly on top of jute, seeds are a bright white and are easily seen, mist the seeds 3 times a day (either with automated irrigation or manual watering with hose); once seeds have germinated, cut back watering to once per day; germination should happen within 2-3 days of planting; harvest after 20 days—dependent on size desired; remove excess material from planting rack; add jute to compost pile; and till the controlled growth medium and get ready for next crop. This crop, as a microgreen, can be densely planted to maximize yields. In an embodiment, the crops could be between ⅛″ to ¼″ of space between them.

In an embodiment, Amaranth growing procedure has about 12 hours of optimal duration of light, about 1 min. daily of optimal duration of watering, about 2.5 grams of weight of seed to use per 1 ft *1 ft section, about 21 days to seed to harvest time and about 65° F. to 75° F. of allowable temperature ranges.

In an embodiment, growth procedure for Arugula is a versatile, spicy green that is popular as both a garnish and the main component of a salad. The mature crop can be cooked while the baby and microgreen versions should be eaten raw.

In an embodiment, growing procedure of Arugula is as follows: weigh out seeds, wet jute thoroughly, scatter seeds evenly on top of jute, mist the seeds 3 times a day (either with automated irrigation or manual watering with hose); once seeds have germinated, cut back watering to once per day; germination should happen within 2-3 days of planting; harvest after 14 days; remove excess material from planting rack and add jute to compost pile; and till soil and get ready for next crop.

In an embodiment, Arugula growing procedure has about 14 hours of optimal duration of light, about 1 min. daily of optimal duration of watering, about 1.25 grams of weight of seed to use per 1 ft *1 ft section, about 14 days to seed to harvest time and about 45° F. to 65° F. of allowable temperature ranges.

In an embodiment, Arugula seeds should be spaced at about ¼41 apart from each other. They can be planted densely as a microgreen but should be harvested at the correct time to ensure a high-quality product.

In an embodiment, growth procedure for baby green Arugula is provided.

In an embodiment, growing procedure of baby green Arugula is as follows: weigh out seeds, wet jute thoroughly, scatter seeds evenly on top of jute, mist the seeds 3 times a day (either with automated irrigation or manual watering with hose); once seeds have germinated, cut back watering to once per day; germination should happen within 2-3 days of planting; harvest after 21 days; remove excess material from planting rack and add jute to compost pile; and till soil and get ready for next crop.

In an embodiment, baby green Arugula growing procedure has about 14 hours of optimal duration of light, about 1 min. daily of optimal duration of watering, about 1.25 grams of weight of seed to use per 1 ft *1 ft section, about 21 days to seed to harvest time and about 45° F. to 65° F. of allowable temperature ranges.

In an embodiment, Arugula baby seeds needs a bit more space than the microgreen. We recommend planting at a ½″ spacing to ensure that the cotyledon leaves do not die before harvest.

In an embodiment, growing procedure of mature Arugula is as follows: weigh out seeds, wet jute thoroughly, scatter seeds evenly on top of jute, mist the seeds 3 times a day (either with automated irrigation or manual watering with hose); once seeds have germinated, cut back watering to once per day; germination should happen within 2-3 days of planting, harvest after 30 days, remove excess material from planting rack and add jute to compost pile; and till soil and get ready for next crop.

In an embodiment, mature Arugula growing procedure has about 14 hours of optimal duration of light, about 1 min. daily of optimal duration of watering, about 1.25 grams of weight of seed to use per 1 ft *1 ft section, about 30 days to seed to harvest time and about 45° F. to 65° F. of allowable temperature ranges.

In an embodiment, mature Arugula crops take more space than the baby greens and microgreens. Seeds should be placed at 2″ apart and thinned if overcrowded.

In an embodiment, growth procedure for Bachelor Button is provided. Bachelor buttons are a beautiful, edible flower that are popular for candying or eating raw. They add a bright color to the plate and come in pink, maroon, purple, blue, white, and black.

In an embodiment, growing procedure of Bachelor Button is as follows: weigh out seeds, wet jute thoroughly, scatter seeds evenly on top of jute, mist the seeds 3 times a day (either with automated irrigation or manual watering with hose); once seeds have germinated, cut back watering to once per day; germination should happen within 5-7 days of planting; flowers will begin to appear after about 60 days; they can be harvested at the node directly below the flower; once plant has stopped flowering, remove both the plant and the surrounding jute; and till soil and get ready for next crop.

In an embodiment, Bachelor Button growing procedure is about 14 hours of optimal duration of light, about 1 min. daily of optimal duration of watering, about less than 1 grams of weight of seed to use per 1 ft *1 ft section, about more than 60 days to seed to harvest time and about 45° F. to 65° F. of allowable temperature ranges.

In an embodiment, Bachelor Button grows large and should have 5 inches of space around it. Plant seeds five inches from each other. We recommended planting 2-3 seeds per spot and then thinning in the future.

In an embodiment, growth procedure for cilantro is provided.

In an embodiment, system can be used to grow baby greens, micro greens and multiple other plants

In an embodiment, the present invention provides several growing structures.

One of the main problems for gardeners who cultivate in standard plastic and ceramic plant pots is root structure. This is because the roots of plants placed in traditional pots can become easily stifled. They get all tangled up and, in severe cases, end up literally strangling the life out of the plant above ground. In an embodiment, the present invention allows air pruning due to which roots are happier and plants are healthy.

The growing racks according to one embodiment, are there to take advantage of building a complete end-to-end growing system. The controlled growth medium enables the development of thin profile growing racks which is unprecedented and state of the art.

In an embodiment, the vertical rack system is a metal framed, stackable system that is designed for a growing medium in a thin layer. This system can be used to grow baby greens and microgreens and other plants and fungi and is not-comparable to hydroponic tray agriculture as hydroponics is unable to grow the full variety of plants as this embodiment can. In another embodiment, the vertical rack system is a steel framed. Such Vertical racks are also called as thin racks.

In an embodiment, it is able to grow crops in ¾″ deep racks with the controlled growth medium and system, hydroponics could not grow in ¾″ deep racks.

Hydroponics is typically unable to grow root vegetables. In an embodiment, in the present application, the system is able to grow root vegetables. In an embodiment, an expandable, modular, deeper rack to grow root vegetables, or perennials, and/or head lettuce have been developed. In an embodiment, beets and carrots are grown in the racks.

In an embodiment, wherein the layer is substantially configured to be required in a thin layer of ¼″, ½″, ¾″, 1″, 5/4″, 3/2″ of container for the plantation of a crop.

In an embodiment, vertical rack system needs low inputs, Lower energy inputs, no extensive pumping required, and light inputs could be mitigated with solar power.

In another embodiment, fabric layer such as the jute material is changed after one to three, or more crops whereas growing media and inoculations are added as needed between crop plantings.

In an embodiment, fabric layer can be made up of natural, synthetic or semi-synthetic layer.

Natural fabric can be cotton, flax and hemp, sisal, jute, kenaf, bamboo, coconut.

In an embodiment, the comprehensive agriculture system requires only low energy input.

In another embodiment, no extensive pumping required, and light inputs could be mitigated with solar power.

In an embodiment, the shipping container has been adapted as a CEA environment for growing systems. This system has advanced reflective insulation, an air exchanger, a de-humidifier, and an air-conditioning cum heating unit.

In an embodiment, hanging racks enables automatic air pruning; and the rack columns are adjustable as well horizontally. so, we can increase the hanging rack columns to increase density, while still be able to service the plants.

In an embodiment, the present invention does not use grow trays. In an embodiment, the present invention allows growth of plants within the rack itself

In an embodiment, the shipping container is about 40′. The shipping container has been adapted as a CEA environment for Agria™ growing systems. This system has advanced reflective insulation, an air exchanger, a de-humidifier, and an air-conditioning cum heating unit.

In an embodiment, CEA container has an adjustable set of racks in four unequal quadrants of the container. Each quadrant can have up to 8 adjustable racks depending on the spacing between them. Each is presently, but not limited to 32 inches (w) ×16 ft (1) for a square foot area of 42.67 sq. ft. per rack×341.33 sq. ft. per quadrant×4=1,365.33 sq. ft. of growing area per container. Depending on the crop, and with a crop plant to harvest cycle of 25 days, offers an annual growing area of approx. 0.45 acres per 40-foot shipping container.

This system is designed to grow larger crops in a vertical space. This is the least developed system but allows maximum usage of a space. In an embodiment, the basket design have been used for growing strawberries in a hoop house and greenhouse and indoor space.

Each rack has a variable set of lights up to 6 or more led lights running the length of each rack. It has a camera for plants and a variety of sensors including soil moisture, relative humidity, and temperature.

In an embodiment, the CEA container has another option of having hanging, adjustable racks in them. Each rack has an adjustable set of LED lights that provide light to the plants. With the minimal load offered by the lights, and the rest of the system, in an embodiment, there is a provision of providing a solar energy system, which makes it the only growing container that can be off the electrical grid and be self-sufficient in power. In an embodiment, the LED lights are lowerable and adjustable to allow for a constant distance to the growing plant during its growth period and have been used for growing crops including tomatoes in a greenhouse. In an embodiment, use lowerable lights in greenhouses for tomatoes and other plants to keep a common distance as the plant grows in height and allows for using lower intensity (lower cost) lights that are fixed. This adjustability as a plant grows is unique.

In an embodiment, pumps that run water and oxygen through system are present. In an embodiment, liquid fertilizer added daily, pH inputs are required, use of individual plastic tray, addition of coco husk, rockwool, or peat moss for each crop.

In an embodiment, it is the only growing container that can be off the electrical grid and be self-sufficient in power.

In an embodiment, programmable UV Lighting for Plant Growth has been used. Specialized UV lighting is provided upon a programmable night schedule when people are not present to help increase the resilience of the plants. This lighting is a supplemental lighting option that is customized for each crop. A sensor system ensures that the lights are not switched on when any people are present to promote human safety.

In an embodiment, special UV lighting profiles are customized for each crop.

In an embodiment, pest management involves the addition of biological control. In another embodiment, Ladybug has been added as a strategy housing for indoor growing spaces.

In an embodiment, biological control bug comprising Coccinellidae, Orion strigicollis, Onus faevigatus, Aphidofetes aphidimyza, Feltielfa acarisuga, Ladybug(Harmonia axyridis), Ladybug (Stethorus punctilfum) worms (Cryptofamus montrouzieri), a brown half-wings (Atheta conaria), Mediterranean Come mites (Amblyseius swirskii), cucumbers come mites (Amblyseius cucumeris) desert Come mites (Amblyseius californicus), trumpets come mites (Amblyseius barkers), ginteol come mites (Amblyseius womersleyi), Palazzo systems come mites (Amblyseius fallacies), Chile come mites (Phytoseiulus persimilis), Western Erie mite (Galendromus occidentalis), cigarettes Louis jombeol (Eretmocerus mundus), bearded jindibeol (Aphidius ervi), ssaljom albeol (Trichogramma evanescens), lighting albeol (Trichogramma ostriniae), greenhouse whitefly jombeol (Encarsia formosa), aphids jombeol (Aphidius abdominalis), Colle Mani jindibeol (Aphidius colemani), hwangon Bee (Eretmocerus eremicus), aphids myeonchung jombeol (Aphelinus asychis), bush clover jindibeol (Aphidius giluensis), gulpari jombeol (Diglyphus isaea), leaf gulpari cocoon bee (Dacnusa sibirica), and peach hoc jindibeol.

Lady bugs are common insect right now for greenhouse growers and organic farmers alike. Almost every year, the prices of them increase a bit and they continue to get sold out. The benefits of Ladybugs feed on the small invertebrates including a wide range of insects which farmers consider pests, such as aphids, mites, and insect eggs in general. Ladybugs are not likely to stay in a space long after being purchased. In most cases, injecting thousands of ladybugs into our hoop house or warehouse left of with about 50 after a couple of days.

Ladybugs like to sleep under umbrella (umbral) shaped plants such as but not limited to Cilantro flowers, Yarrow, Carrot Flowers, Dill/Fennel Flowers, Elderberry Flowers, Queen Anne's Lace, Sea lavender.

In an embodiment, the food sources for biological control bug comprising but not limited to Pollen, Aphids, Mites, Insect eggs. Having both the structures and food source in place helps in ladybug attraction and retention.

However, having these perennial, large, rooted plants within the growing rack spaces seems unlikely for the ¾ inch growing racks. In an embodiment, artificial flowers, along with pollen collected from landscape plants, are planted to provide adequate housing and supplementary food for these critters.

In an embodiment, in the system there have been use of a bridge concept as well and adding “banker” plants to keep the ladybugs retain in the system.

In an embodiment, the comprehensive growing system procedure don't require transplantation. It saves on transplantation shock and shortens growth cycle, increased productivity.

In an embodiment, there is an integrated sensor and closed loop monitoring and control system to increasingly automate the system.

In an embodiment, the system includes, but is not limited to the following sensors: Soil Moisture, Soil Temperature, Soil pH, Air Relative Humidity, Air Temperature, Air Flow, Light, Light (Par/PPFD), Infrared, Motion, Water Flow, Water Temperature, Video.

In an embodiment, the innovative science of Controlled Environment Agriculture (CEA), combines with a focus on vertical farming with traditional close-to-nature, not industrial, farming practices; and sensor and information and communication technologies; and eventually integrating with robotics.

In an embodiment, present invention employs organic based growth structure (made from composted materials, with some minerality) for drainage.

In an embodiment, present invention employs organic based growth structure, made from the composting of wood litter, leaves, food waste, and other green sources. Bone meal and sand is added to amend the texture into a loam. The growing medium is sifted into a fine particulate size.

In an embodiment, the controlled growth medium is non-soil, non-liquid an organic based growth structure from natural source with customizable micro-biomes for plants.

In an embodiment, the controlled growth medium has minerality may be less than 15% w/w. In an embodiment, lower limit of minerality may be 2% w/w, 5% w/w, 7% w/w, 10% w/w, 15% w/w, 20% w/w and upper limit of minerality may be 10% w/w, 15% w/w, 20% w/w, 25% w/w, 30% w/w or more. In an embodiment, controlled growth medium may free of minerality.

In an embodiment, the present invention is different from hydroponics. Hydroponics includes rockwool, peatmoss or coconut husk, all need to be moist before putting into the hydroponic system. Rockwool needs to be soaked thoroughly before you can plant seeds into it and the person handling rockwool should wear gloves and a mask, especially when the material is dry. Coconut husks need to be broken from the brick it comes in, and peat moss sometimes needs the larger chunks broken down. Further, in hydroponics seeding procedures vary from plant to plant. For example: if we take Arugula growth in hydroponics, seedlings are first placed in a dark space until they are sprouted, then they are moved to another system, which is lit. The crop in hydroponic located and then taken out of tray to be harvested. The rockwool or growing medium is put into a compost container. Though, good practices would rinse out the nutrient rich water and drain it as best as possible before discarding it. Any crop residue is thrown away and the trays must soak in a warm cleaning solution and be thoroughly dried before being able to be used again. Further, in hydroponics each 10*20 tray can usually fill up one ounce container, so the retrieving of trays and packaging materials can add up on time. Whereas, in an embodiment, the present invention is simpler compared to hydroponics. In an embodiment, the present invention employs a very simple preparing planting plot. It employs wet jute down with the misting irrigation system in place. Similarly, seedling is also easy in current invention. Weigh out Arugula seed weight according to recipe and then broadcast seeds onto jute material. We can turn misters onto “seedling” setting. Lights can be on-off before germination. After germination (green has appeared) change irrigation setting to once per day. In an embodiment, the present invention, crops are harvested from pot/plot. Usually, 10-12-ounce packages for each 4′*8′ section is enough. The cleaning and preparing for next cultivation of crop is also simple compared to hydroponics. In an embodiment, the present invention removes jute and replace with a fresh piece. We can plant immediately.

In an embodiment, according to this invention for example growth of per plant/per season or year is about 2 to 4 times of growth compared to hydroponics. For example, but not limited to growth of tomatoes according to this invention per plant per season growth is about 50 to 100+ lbs./plant per season whereas in hydroponics growth is about 25+ lbs. Similarly, growth of strawberries per plant per year according to this invention is about 5+ lbs./plant per year, whereas in hydroponics it is approximately 3 lbs.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability.

In an embodiment, the present invention saves on transplantation shock and shortens growth cycle, increased productivity.

All percentages, ranges are in weight unless explicitly written therein.

### WORKING EXAMPLES

### Example 1: Strawberry Growing Procedures

Materials
a. Strawberry plants producing runners
b. Jute Pods
c. Wire/string
d. Clippers
e. Battery powered leaf blower

Preparing Jute Pod
a. Cut a 3″×3″ square of jute.
b. Place growing media as per this invention in center of jute.
c. Close the jute around the growing media and secure with string.

Propagating Strawberries from Runners
a. Take a jute pod and a strawberry runner. Use a string to wrap the base of the runner to the jute ball so that the base of the runner is in contact with the jute.
i. Make sure not to damage the leaves or stems of the runner as this can kill the plant.
ii. If using wire, be sure not to puncture the runner when securing to the jute pod.
b. Lightly water the jute pod and runner.
c. Keep the jute pod attached to the mother strawberry plant and leave in the growing media for 7 to 14 days. Water daily.
i. You should see the runner's root system grow into and through the jute ball.
d. Cut the runner lose from the mother plant and plant the whole jute pod into the new troughs containing the growing media as per this invention.
e. Water the planted jute pod daily.

Pollination
a. Use a battery-operated leaf blower and blow the blooms of the strawberry plants twice a day;

once in the morning and once in the afternoon.
i. Stand NO LESS than 5
feet away from each plant. DO NOT use the leaf blower too close to the plants or you will damage them.
ii. The plants should “bounce”—NOT held down by the air.

Maintenance
a. Water the planted jute pod daily for 15 minutes.
b. Remove old leaves as needed so they do not fall into the growing media. Re-inoculate the growing media twice a year. This can be done at any time throughout the growing process.

Harvesting
a. Harvest the strawberries when they are ripe.

Post-Harvest
a. Cut the strawberry plants at the base leaving the root system in the growing media.
b. Make indentations in the troughs using your index finger to make space for new jute pod plantings.
c. Plant new jute pods in between removed plants.

### Example 2: Tomato Growing Procedures

Materials
a. Tomato seeds
b. 3 % hydrogen peroxide.
c. 512 slot seed starting tray
d. 2″×2″×2″ 50 slot trays
e. Agria growing media
f Heating mat
g. Grow light
h. Numerous 8″ zip ties/string
i. Battery powered leaf blower
j. Clippers

Seeding
a. Take your tomato seeds and soak them in 3% hydrogen peroxide.
i. This takes the disease/residue off of the seeds. No need to rinse hydrogen peroxide.
b. Completely fill the 512 slot seed starting tray with growth media of this invention.
c. Remove the seeds from the hydrogen peroxide and place them in the 512-slot seed starting tray on top of the growth media of this invention.
d. Place the seeded growing trays onto a heating mat.
i. Keep air temperature at 85F for germination and growing
e. Place the growing light over the top of the seeded growing trays.
f Lightly mist the seeds twice per day until the growing media is moist.
g. Seeds should germinate in 3 to 7 days. h. If seeds are not germinating by 10 days, take the seeds out and repeat the seeding process from step a.
i. Let plants grow till the plants have reached about 1 inch tall. Should take 10 days.

Transplant 1
a. Loosen the dirt in the growing trays by gently pinching the bottom of the seeded growing tray until the seedling begins to come free.
b. Fill the 2″×2″×2″ trays with growth media of this invention. With your index finger, make a small indentation into the growth media to make space for the seedlings you are about to transplant.
c. Gently remove the whole 1-inch seedling out of the 512 growing tray by grabbing near the base of the plant. Place each seedling in the 2″×2″×2″ 50 count tray. Cover the roots of the transplanted tomato seedlings with loose growing media. Lightly water the transplanted tomato plants until the growing media is moist.
d. Place the 2″×2″×2″ growing tray on a table in the greenhouse.
i. In winter months, keep the newly seeded tray under the grow light for supplemental lighting.
e. Grow the transplanted seedlings until they are 4 inches tall. Water daily to keep soil moist.

Transplant 2
a. Make a 2-inch indentation in the growing trough using your index finger.
b. Pinch the bottom of the tray to loosen the root ball in the growing tray and gently remove the 4-inch plant by grabbing near the base of the plant. Remove the root ball from the growing tray.
c. Place root ball in the growing trough in 1 foot intervals.
d. Loosely cover the root ball with growing media and water until moist.

Maintenance
a. Water the tomato plants daily for two minutes.
b. For every 1 foot of growth, use the 8 inch zip ties provided to secure the plants to the trellis.
i. When zip tying the plants to the trellis, only lock the zip tie using the first securing mechanism. DO NOT squeeze the zip tie to the trellis as this will cut the plant in half later in its growth stages.
c. Remove all suckers immediately as necessary.
d. Twice a year re-inoculate the growing media (this can happen at any point throughout the growing process).
e. Maintain greenhouse temperature of 85 F at all times.

Pollination
a. Use a battery-operated leaf blower and blow the blooms of the tomato plants twice a day; once in the morning and once in the afternoon.
i. Stand NO LESS than 5
feet away from each plant. DO NOT use the leaf blower too close to the plants or you will damage them.
ii. The plants should “bounce”—NOT held down by the air.

Lighting
a. Always maintain a 14 hour day in the greenhouse.
i. DO NOT let your lighting requirements get under 14 hours.

Harvesting
a. Gently pick the tomatoes when they are fully ripened or slightly before.

Post-Harvest
a. Cut plant at its base where the growing media meets the stalk.
b. Throw away the stalks.
i. Compost bin for circular system.
c. Make indentations using your index finger for the next crop between the remaining plant roots.

### Example 3: Lettuce Planting Procedures

Materials
a. Small metal container
b. Lettuce seeds
c. Harvest knife
d. Green Harvesting Container

Planting/Germination
a. In the growing racks, use your index finger to create a small, half inch indentation in the growing media.
b. Take the small metal container and fill it with your desired seeds.
c. Take seeds and place 1-2 seeds in each indentation.
d. Loosely cover seeds with a small amount of growing media and lightly mist with water until growing media is moist and water begins to drip from below the rack.
e. Mist the newly planted seeds with water twice a day, once in the morning and once in the evening until water begins to drip from the bottom of the rack.

Maintenance
a. Irrigation settings should be set to “rain” or “shower” setting. Make sure these settings water the crops at least once per day.

Harvesting (progressive harvesting)
a. Prepare an ice bath to wash the greens.
b. Using the harvest knife, cut the outer most leaves on each head of lettuce. Cut leaves progressively towards the center of the lettuce head leaving the inner most leaves remaining.
i. Make sure to leave at least 3-4 leaves per plant as this will stimulate further growth in each lettuce head.
c. Place your harvested lettuce greens in the green harvesting container.
d. Starting at the closest head of lettuce and moving left to right, progressively harvest from each head of lettuce.
i. This method of harvesting each new head of lettuce allows for long term preservation of the crop as well as a methodical approach to overharvesting prevention.

Harvesting (whole head)
a. Prepare an ice bath to wash the greens
b. Using a harvesting knife, grab the base of the head of lettuce. Cut at the base of the lettuce head.
c. Place the lettuce head in the green harvesting container.

Ice Bath/Washing Greens
a. After completing the desired harvest, take the harvested greens in the green harvesting container and submerge the greens in the ice bath.
b. Submerge the greens in the ice bath for 60 seconds.
i. This process removes latent insects that might remain on lettuce leaves.
c. Remove the greens from the ice bath. Using paper towels, dry the greens and place them in their respective packaging.
d. Store the greens in a cold storage unit until delivery.
e. For seeds that fail to germinate, make new indentations and replant with 1 — 2 new seeds.
f For plants where both seeds germinate, remove the smaller of the two plants and leave the larger for further growth.

### INCORPORATION OF REFERENCE

All publications, patents and patent applications cited in this specification are incorporated herein by reference in their entireties as if each individual publication, patent or patent application were specifically and individually indicated to be incorporated by reference. While the foregoing has been described in terms of various embodiments, the skilled artisan will appreciate that various modifications, substitutions, omissions, and changes may be made without departing from the spirit thereof.

1. A composition comprising:
a controlled growth medium comprising:
a customizable microbiome comprising a nematode, an inoculant, a natural fiber comprising a long fiber comprising jute, and a soil conditioner;
wherein the composition does not have a chemical pesticide and a chemical fertilizer; and
wherein the composition is configured for controlled environment agriculture without hydroponics.

2. (canceled)

3. The composition of claim 1, wherein the controlled growth medium further comprising a compost and the composition further comprises sand.

4. The composition of claim 1, wherein the soil conditioner comprises humic acid and fulvic acid.

5. (canceled)

6. The composition of claim 1, wherein the inoculant comprises an organic fertilizer, a seaweed and worm casting, and wherein the customizable microbiome comprises a community of microorganisms.

7. (canceled)

8. The composition of claim 6, wherein the community of microorganisms comprising at least one of a bacterial system, a fungi system, a protozoa, or a flagellates.

9. (canceled)

10. The composition of claim 8, wherein a tiller is configured to revert a community of microorganisms in the controlled growth medium by a tiling process; wherein the tiller comprises a biological tiller and /or a physical tiller or combination thereof.

11-34. (canceled)

35. The composition of claim 1, wherein the nematode comprises a fungus eating nematode.

36. The composition of claim 1, wherein the composition has a minerality less than 15% w/w of a total weight of the composition.

37. The composition of claim 2, wherein the controlled growth medium is in range of 60%-80% by weight, and sand is in ratio of 20%-40% by weight in a total weight of the composition.

38. The composition of claim 2, wherein the compost comprising essentially about 10% to 30% by weight of a crop scrap; about 15% to 40% by weight of Wood debris, about 5% to 30% by weight of a yellow hay, about 1% to 20% by weight of fallen leaves, about 0 to 10% by weight of a food scraps and about 5% to 25% by weight of a disposed Jute in a total weight of the composition.

39. A composition comprising:
a) sand by 25% weight of a total weight of the composition;
b) a controlled growth medium comprising of a customizable microbiome comprising a fungus eating nematode, an inoculant, a natural fiber comprising jute, compost and a soil conditioner comprising humic acid, iron, sulphur and fulvic acid;
wherein the controlled growth medium is about 75% weight of the total weight of the composition;
wherein the composition has a minerality less than 15% w/w of a total weight of the composition;
wherein the composition does not have a chemical fertilizer and a chemical pesticide.

40. The composition of claim 39, wherein the inoculant comprises an organic fertilizer, a seaweed and worm casting.

41. The composition of claim 39, wherein the customizable microbiome comprises a community of microorganisms comprising a bacterial system, a fungi system, a protozoa, and a flagellates.

42. The composition of claim 39, wherein the sulphur is about 1.50 wt. %, the iron is about 2.25 wt. %, the humic acid is about 45 wt. % and fulvic acid is about 14 wt. % in a total weight of the soil conditioner.

43. The composition of claim 39, wherein the composition is configured to allow germination of a seed directly on a surface of the controlled growth medium without requirement of a transplantation of a seedling produced from the seed.

44. The composition of claim 39, wherein the compost comprising of:
a) 10% to 30% by weight of a crop scrap;
b) about 15% to 40% by weight of Wood debris,
c) about 5% to 30% by weight of a yellow hay,
d) about 1% to 20% by weight of fallen leaves,
e) about 0 to 10% by weight of a food scraps, and
f) about 5% to 25% by weight of a disposed Jute, in a total weight of the compost.

45. A composition comprising::
a) sand by 20-40% weight of a total weight of the composition;
b) a controlled growth medium comprising of a customizable microbiome comprising a fungus eating nematode, an inoculant, a natural fiber comprising jute, compost and a soil conditioner comprising humic acid, iron, sulphur and fulvic acid;
wherein the controlled growth medium is about 60-80% weight of the total weight of the composition;
wherein the composition has a minerality less than 15% w/w of a total weight of the composition;
wherein the composition does not have a chemical fertilizer and a chemical pesticide.

46. The composition of claim 45, wherein the inoculant comprises an organic fertilizer, a seaweed and worm casting.

47. The composition of claim 45, wherein the customizable microbiome comprises a community of microorganisms comprising a bacterial system, a fungi system, a protozoa, and a flagellates.

48. The composition of claim 45, wherein the composition is configured to allow germination of a seed directly on a surface of the controlled growth medium without requirement of a transplantation of a seedling produced from the seed.
